(19) United States
(12) Patent Application Publication
(10) Pub. No.: US 2024/0057220 A1
(43) Pub. Date: Feb. 15, 2024

(54) HIGH INTENSITY RAPID HEAT FLUX GENERATOR AND MULTIPLIER

(71) Applicant: LITEL INFRARED SYSTEMS PVT. LTD, Pune (IN)

(72) Inventors: Mahendra SHAH, Pune (IN); Nilay SHAH, Pune (IN)

(73) Assignee: LITEL INFRARED SYSTEMS PVT. LTD, Pune (IN)

(21) Appl. No.: 18/258,284

(22) PCT Filed: Dec. 20, 2021
(86) PCT No.: PCT/IN2021/051189

§ 371 Date: Jun. 19, 2023

(30) Foreign Application Priority Data
Dec. 20, 2020 (IN) 202021026122

(51) Int. Cl. H05B 1/02; H05B 3/08; H05B 3/00

(52) U.S. Cl. CPC H05B 1/023; H05B 3/08; H05B 3/0038

(57) ABSTRACT

Disclosed is a modular and expandable high intensity rapid heat flux generator and multiplier (150) for generating uniform radiant heat flux upwards of 3 MW/m² for extended duration up to 300 sec and more, for testing thermal capabilities of a test object (200). The heat flux generator (150) consists of a plurality of heat sources (100) and a control module. Each heat source (100) comprises a housing (15) having a plurality of quartz tubes (20) arranged therein. Each quartz tube (20) accommodating from 2 to 4 heat emitters (30) therein, is provided with a cooling arrangement, wherein a cooling medium (40) from an external reservoir (50) is circulated through the quartz tubes (20) for controlling the surface temperature of the heat emitters (30) for their normal functioning, and for delivering maximum radiant heat flux. The control module controls simultaneous cooling and dynamic flux stabilization either continuously or in pulse.

### FIELD OF THE INVENTION

The present invention generally relates to thermal engineering and more particularly relates to a modular and expandable high intensity rapid heat flux generator suitable for high intensity thermal simulation for testing of materials at extreme high thermal conditions.

### BACKGROUND OF THE INVENTION

It is a common practice to use quartz infrared heat lamps for heating and curing applications which include thermal testing of materials and products in aerospace labs, material labs and in manufacturing environments. In aerodynamic testing, components of aerospace chambers, components, high speed vehicle parts and in some cases the entire space vehicle have to be adequately thermally tested. In such requirements infrared heat through quartz heat sources offers the most efficient energy transfer from the heat source to the product. The IR heat sources or emitters offer flexibility in targeting components of diverse geometry as well as zoning options to test specific areas of the parts.

A majority of these simulation tests are conducted by placing a series of infrared heat lamps in a row horizontally or vertically based on the geometry of the test object, such that maximum radiation is directed onto the test subject.

Due to the high temperatures generated during above test, the heat sources tend to heat each other and decay rapidly thereby limiting the time available to expose the given object to the high intensity heat flux. Typically, this duration with the existing arrangement is limited to 40-50 seconds at full power. In addition, uncontrolled cooling or creating or introducing cooling agents in the entire setup in a wholesale way can cool down the test object thereby further compromising the full potential of the test. Finally, the existing methodology is largely suitable to flat 2-dimensional materials. Uniformity of heat flux is greatly affected when performing thermal tests on 3 dimensional components or subassembly of components. Finally, there is a limitation of maximum radiant heat flux generated with the existing arrangement.

Accordingly, there exists need to provide a high intensity rapid heat flux generator and multiplier suitable for high intensity thermal simulation for testing of materials and components that can overcome the drawbacks of prior art techniques.

### OBJECTS OF THE INVENTION

An object of the present invention is to orchestrate high intensity thermal simulation for testing of materials and components for their durability at extreme high thermal conditions.

Another object of the present invention is to facilitate an efficient energy transfer from the heat source to the target object during thermal testing of metallic or non-metallic objects.

Yet another object of the present invention is to offer higher duration and high intensity radiant flux in continuous or pulse mode onto a test object.

Still another object of the present invention is to provide modular and expandable heat flux generator that can be utilized to target uniform radiant heat flux to large surface areas up to 3 m² to 5 m² in various shapes and sizes.

Still another object of the present invention is to provide a high intensity rapid heat flux generator and multiplier that is versatile in nature and can be utilized in air, vacuum, pressure chambers and such combination thereof.

### SUMMARY OF THE INVENTION

Accordingly, the present invention provides a high intensity rapid heat flux generator and multiplier for generating uniform radiant heat flux upwards of 3 MW/m² for extended duration up to 300 sec and more, for testing thermal capabilities of a test object. The modular and expandable heat flux generator of the present invention can be utilized to target uniform radiant heat flux to large surface areas up to 3 m² to 5 m² in various shapes and sizes. The high intensity rapid heat flux generator and multiplier consists of a plurality of heat sources and a control module. Each heat source of the plurality of heat sources comprises a housing made of material capable of withstanding high thermal intensity for extended duration of operation. The housing is fitted with a plurality of sensors for capturing control parameters and provided with cooling jackets. A plurality of quartz tubes is arranged in the housing to form clusters. Each quartz tube from the plurality of quartz tubes accommodating two to four heat emitters therein, preferably IR emitters, is fitted with an inlet and an outlet for a cooling medium. The cooling medium from an external reservoir is circulated through the quartz tubes thereby controlling the emitter surface temperature for its normal functioning and for delivering maximum radiant heat flux. In an embodiment, the cooling medium is suitably selected from water, air, liquid nitrogen and combinations thereof. The control module includes an input unit, a processing unit, a memory unit and a display unit. The control module receives real time data from the test object and from the plurality of sensors on the housing in and controls simultaneous cooling and dynamic flux stabilization either continuously or in pulse, in accordance with the signals received. The plurality of heat sources is arranged in a in layers and geometric modules using precision reflectors so that maximum radiant heat flux is converged in a focused manner and enhanced with custom designed precision reflectors, thereby creating a total heat flux cumulative and cascading in output onto the test object. The volume and flow of the cooling medium is decided depending upon duration and output of heat flux.

### BRIEF DESCRIPTION OF THE DRAWINGS

The objects and advantages of the present invention will become apparent when the disclosure is read in conjunction with the following figures, wherein

FIG. 1 shows a sectional view of a high intensity rapid heat flux generator system along with a test object, in accordance with an embodiment of the present invention;

FIGS. 1A, 1B and 1C respectively show enlarged front view, side view and top view of a quartz tube of the high intensity rapid heat flux generator shown in FIG. 1, in accordance with an embodiment of the present invention

FIG. 2 shows a sectional view of a heat source of the high intensity rapid heat flux generator system, in accordance with an embodiment of the present invention;

FIGS. 2A and 2B respectively show side views and a cross sectional view of a quartz tube of the high intensity rapid heat flux generator shown in FIG. 2, in accordance with an embodiment of the present invention;

FIGS. 3a & 3b show cluster arrangements of the plurality of quartz tubes in the high intensity rapid heat flux generator in accordance with the present invention,

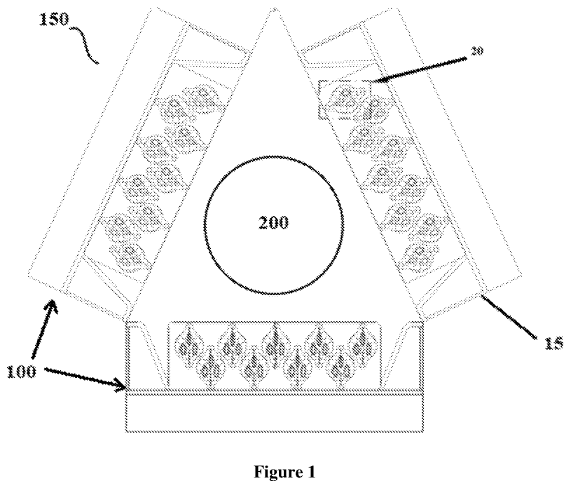

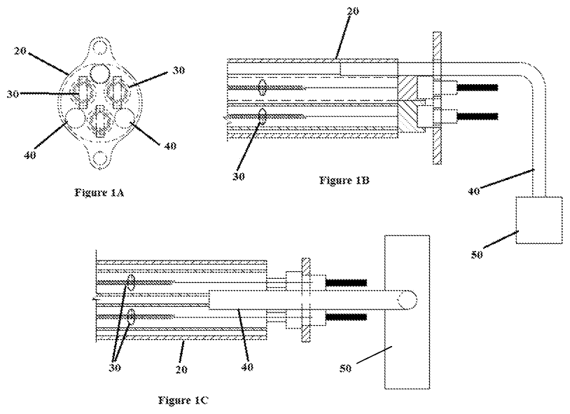

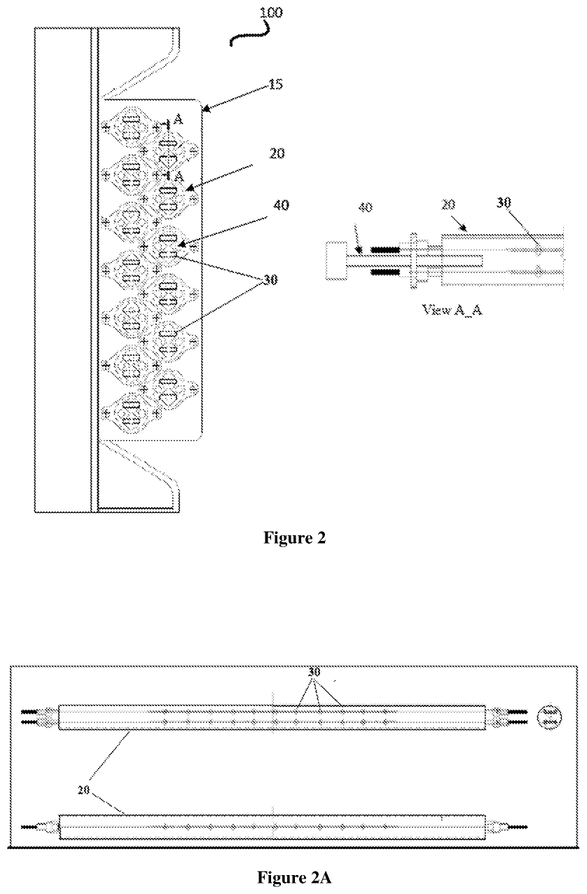

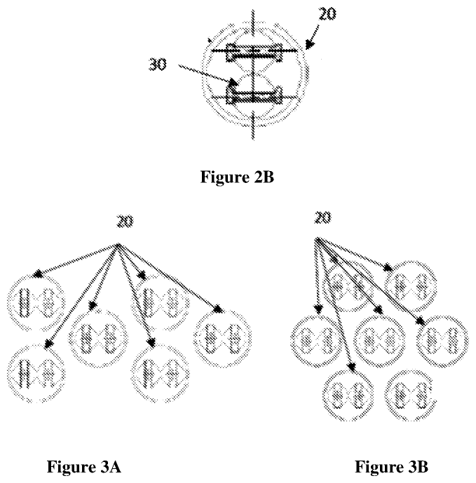

### DETAILED DESCRIPTION OF THE EMBODIMENTS

The foregoing objects of the present invention are accomplished and the problems and shortcomings associated with the prior art, techniques and approaches are overcome by the present invention as described below in the preferred embodiments.

The present invention provides a high intensity rapid heat flux generator and having plurality of heat sources arranged as clusters, encapsulated in an engineered module with sensors, concurrent cooling auxiliaries and precise electronic power controls. The individual components work synergistically and organize a heat flux multiplier (upwards of 3 MW/m²) efficiently and reliably for multiple cycles of high intensity heat flux generation with highly reduced decay to the heat sources.

The present invention is illustrated with reference to the accompanying drawings, throughout which reference numbers indicate corresponding parts in the various figures. These reference numbers are shown in bracket in the following description and in the table below.

TABLE

| Ref No: | Component |
|---|---|
| 15 | Housing |
| 20 | Quartz tubes |
| 30 | Heat emitters |
| 40a | Cooling medium input |
| 40b | Cooling medium output |
| 40 | Cooling medium |
| 50 | Cooling medium reservoir |
| 100 | Heat source |
| 150 | high intensity rapid heat flux |
| | generator and multiplier |
| 200 | Test object |

Referring to figures from 1 to 3, a high intensity rapid heat flux generator and multiplier (150) (‘hereinafter referred as ‘the heat flux generator (150)’) is shown, in accordance with the present invention. The heat flux generator (150) is capable of generating heat flux upwards 3 MW/m² for extended duration up to 300 sec for thermal testing of a test object (200). The heat flux generator (150) comprises a multiple number of heat sources (100), each heat source (100) comprising a housing (15), a plurality of quartz tubes (20), heat emitters (30), a cooling arrangement; and a control module (not shown).

The housing (15) is an engineered housing made of material capable of withstanding high thermal intensity for extended duration of operation. The housing (15) is provided with a shape, materials, coatings and reflecting surface allowing high thermal intensity for extended duration of operation. In an embodiment, the housing (15) is provided with reflectors selected from gold reflectors, silver reflectors and like. The housing (15) is configured with a plurality of temperature sensors and a provision for cooling plates or cooling jackets (not shown). In an embodiment, the housing (15) is made up of materials can sustain high temperatures and are good reflectors of radiant heat flux selected from stainless steel, titanium, aluminum and alloys thereof. In another embodiment, the housing (15) coated with materials selected from gold, silver and like to further enhance the heat flux. Depending on the object to be heated or tested, the housing (20) can be of any shape selected from a circular, a parabolic, an elliptical or a box type to converge the heat flux on to the test object (200).

The plurality of quartz tubes (20) is arranged in the housing (15) to form clusters/layers. Each quartz tube of the plurality of quartz tubes (20) accommodates multiple heat emitters (30) therein, the number of heat emitters ranging from 2 to 4. The plurality of quartz tube (20) is arranged such that the heat flux from all the heat emitters (30) directs the heat flux in a focused manner on a target object (200). In a preferred embodiment, the heat emitters (30) are infrared (IR) emitters. Specifically, the infrared emitters are quartz tungsten emitters and lamps powered on to transfer radiant heat flux to a target object. In an alternate embodiment, heat emitters (30) are selected from carbon emitters, laser heaters, VCSEL (vertical cavity surface emitting laser) sources, semi-conductor heat sources or a combination of the above and like.

Each quartz tube of the plurality of quartz tubes (20) is fitted with an inlet (40a) and an outlet (40b) for a cooling medium (40). The cooling medium (40) from an externally placed reservoir (50) circulates through the quartz tube thereby cooling the housing (15) and maintaining and keeping the intrinsic temperature of heat emitter's (30) under control. In an embodiment, the cooling medium is suitably selected from water, air, liquid nitrogen and combination thereof. In an embodiment, each quartz tube from the plurality of quartz tubes is having sufficient diameter to accommodate multiple heat emitters (30) with space for flow of the cooling medium (40). The diameter of the quartz tube (20) may vary based on the overall heat flux generation requirements. Similarly, the cooling flow volume and delivery mode is selected as per the flux output and duration. Thus, intrinsic temperature of the heat emitters (30) can be maintained and kept under control.

The control module (not shown) consists of an input unit, a processing unit, a memory unit and a display unit. The test object (200) and the housing (15) are equipped with plurality of sensors for capturing control parameters selected from temperature, pressure, mechanical forces, sound and like. The data from sensors is received in the input unit. The memory unit is configured to coordinate functions of the plurality of heat sources (20) according to the sensor data. The control module is adapted to direct a controlled high power to each of the heat emitters (30). This ensures that a required heat flux is generated by the heat emitters (30) and efficiently delivered to the specific locations of a target object. The control module coordinates the simultaneous cooling and dynamic flux stabilization of the heat flux generator (150) in accordance with the signals from the plurality of sensors such that the integrity of the entire system is maintained for the duration of the simulation or operation period. Preferably, the control module includes an automated high-speed data acquisition system that dynamically collects temperature readings in detail at multiple points across the surface of the test object in real time for the entire duration of the test or operation.

In accordance with an aspect of the present invention, the plurality of heat sources (100) are converged in a focused manner to create a total thermal heat flux that is cumulative and cascading in each trial. High intensity radiation is generated under controlled condition for long duration for repeated use. Multiple number of heat sources (100) are arranged in various geometric modules using appropriate precision reflectors (not shown) for focusing maximum radiant energy onto the object from all directions. Combinations of multiple heat sources (100) when placed in special arrangements can be utilized in surrounding the three dimensional product such that the high intensity flux is seen by almost all the surfaces of the 3D product. The heat sources (100) can be layered to enhance (multiply) the radiant energy in the focused surface. A specific arrangement of heat sources (100) along with a combination of coatings on the outer side of the encasing of the each heat emitter (30) contributes towards a “multiplier” effect. The sequence of measured energy to be distributed to each heat source (100) in the required duration is orchestrated in accordance with the input data configured in the control module. The control module also coordinates the simultaneous cooling of the entire heat flux generator system and dynamic flux stabilization in accordance with the signals from the plurality of sensors such that the integrity of the entire system is maintained for the duration of the simulation or operation period.

### Advantages of the Invention

The invention provides a methodology and equipment such that multiple heat sources (100) in a unique and expandable arrangement are powered synchronously using sophisticated control module, creating a multiplier effect of high intensity uniform heat flux, cumulatively for an extended period of time about greater than 300 seconds.
The modular and expandable heat flux generator (150) can be utilized to target uniform radiant heat flux to large surface areas up to 3 m² to 5 m in various shapes and sizes.
The heat flux generator (150) is versatile in nature and can be utilized in air, vacuum, pressure chambers and such combination thereof.
The quartz tubes (20) provide transparency to infrared radiation and high thermal shock resistance thereby minimizing energy losses due to absorption.
The infrared emitters with specific wavelengths as per test objects used as heat emitters (30) provide heat sufficient enough to be deep penetrated into the material bodies therefore further contributing to thermal efficiency. Therefore, the heat flux generator (150) can be a preferred mode for numerous thermal simulations and production operations including those in the aerospace industry and a diverse industry base.
The heat flux generator (150) can be made capable of operation in vacuum, pressurized and open environments.
The heat flux generator (150) is viable in a large or compact modular operational setup as per the requirements of the components to be thermally tested.
The arrangement of heat sources (100) in the heat flux generator (150) with a concurrent cooling arrangement protects the heat sources (100) from erosion and preliminary electrical or mechanical failure due to the intensity of heat generation in a very compact space.
The heat flux generator (150) provides a multiplier effect of the total heat flux output.
The heat flux generator (150) provides an in an in-house facility for thermal testing on both flat object and three dimensional objects.
The heat flux generator (150) can be utilized for thermal simulation or treatment on metal, plastic, composite or special material components or assembly of components.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the scope of the present invention.

We claim:

1. A high intensity rapid heat flux generator and multiplier (150) for generating uniform radiant heat flux upwards of 3 MW/m² for extended duration up to 300 sec and more for testing thermal capabilities of test object (200), the test object (200) equipped with plurality of sensors for capturing control parameters; the high intensity rapid heat flux generator and multiplier (150) consisting of:
a plurality of heat sources (100), each heat source from the plurality of heat sources (100) comprising:
a housing (15) made of material capable of withstanding high thermal intensity for extended duration of operation, the housing (15) fitted with a plurality of sensors for capturing control parameters and provided with cooling jackets,
a plurality of quartz tubes (20) arranged in the housing (15) to form clusters, each quartz tube from the plurality of quartz tubes (20) accommodating a heat emitters (30) therein and fitted with an inlet (40a) and an outlet (40b) for a cooling medium (40),
wherein the cooling medium (40) from an external reservoir (50) is circulated through the quartz tubes (20), thereby controlling the surface temperature of the heat emitters (30) for their normal functioning, and for delivering maximum radiant heat flux; and
a control module including an input unit, a processing unit, a memory unit and a display unit, the control module receiving data of control parameters from the test object and from the plurality of sensors on the housing (15) in real time and controlling simultaneous cooling and dynamic flux stabilization either continuously or in pulse, in accordance with the signals received,
wherein the plurality of heat sources (100) is arranged in a way that maximum radiant heat flux is converged in a focused manner and enhanced with custom designed reflectors, thereby creating a total heat flux cumulative and cascading in output onto the test object (200), and the volume and flow of the cooling medium (40) is decided depending upon duration and output of heat flux.

2. The high intensity rapid heat flux generator and multiplier (150) as claimed in claim 1, wherein the heat sources (100) are arranged in layers and geometric modules using precision reflectors.

3. The high intensity rapid heat flux generator and multiplier (150) as claimed in claim 1, wherein the cooling medium is suitably selected from water, air, liquid nitrogen and combinations thereof.

4. The high intensity rapid heat flux generator and multiplier (150) as claimed in claim 1, wherein the housing (15) is made of material selected from stainless steel, titanium, aluminum alloys thereof that can sustain high temperatures and are good reflectors of radiant heat flux.

5. The high intensity rapid heat flux generator and multiplier (150) as claimed in claim 1, wherein the control parameters are selected from temperature, pressure, mechanical forces, sound and like.

6. The high intensity rapid heat flux generator and multiplier (150) as claimed in claim 1, wherein the heat emitters (30) are any one selected from infrared (IR) emitters, carbon emitters, laser heaters, vertical cavity surface emitting laser sources, semi-conductor heat sources, and a combination thereof.

7. The high intensity rapid heat flux generator and multiplier (150) as claimed in claim 1, wherein the heat emitters (30) are infrared (IR) emitters.

8. The high intensity rapid heat flux generator and multiplier (150) as claimed in claim 1, wherein each quartz tube from the plurality of quartz tubes (20) accommodates two to four heat emitters (30) therein.
